(19) United States
(12) Patent Application Publication
(10) Pub. No.: US 2010/0037829 A1
(43) Pub. Date: Feb. 18, 2010

(54) Easy hatch aquarium

(76) Inventor: Dennis E. Binkley, Seatle, WA (US)

Correspondence Address: JENSEN + PUNTIGAM, P.S., 2033 6th Ave, Suite 1020, SEATTLE, WA, 98121, US

(21) Appl. No.: 12/228,760

(22) Filed: Aug. 15, 2008

(51) Int. Cl. A01K 63/00; G06Q 90/00

(52) U.S. Cl. 119/248; 705/500

(57) ABSTRACT

An easy hatch aquarium, methods for using the same, and methods for distributing marine life eggs are disclosed. An easy hatch aquarium can be sold along with information allowing the purchaser to subsequently order delivery of marine life. An exemplary aquarium includes a main compartment, a hatching compartment for hatching marine life eggs, and a magnification element magnifying contents of the hatching compartment.

### BACKGROUND

Aquariums provide an interesting and educational environment for marine life of all kinds. Aquariums can be sold through many different channels, such as in fish stores, hobby stores, toy stores, person to person and over the internet. In contrast, there are fewer available channels for selling marine life to live inside aquariums. Typically, sales of marine life are restricted to fish stores, which specialize in professional acquisition, care and distribution of marine life. The reason for this is straightforwardly that marine life could be severely damaged or die if subjected to the environments imposed by most sales channels. It is therefore advantageous to extend available marine life sales channels to better match available channels for aquariums, providing greater convenience for consumers and better point-of-sale access to consumers for sellers of marine life.

Furthermore, while the basic care and feeding of marine life in an aquarium is easily learned by many hobbyists, causing marine life eggs to hatch in an aquarium presents additional challenges. It is therefore advantageous to provide an easy hatch aquarium in which hatching marine life eggs can be easily attempted with a high rate of success, and in which the process of hatching and subsequent growth can be studied.

### SUMMARY

In consideration of the above-identified need in the art, the present invention provides an easy hatch aquarium, methods for using the same, and methods for distributing marine life to the easy hatch aquarium. In general, an easy hatch aquarium can be sold along with information allowing the purchaser to subsequently order delivery of marine life. This allows effective sale of marine life along with the aquarium via all channels through which the aquarium itself may be sold. It also provides convenience to consumers who can purchase aquariums through a wide variety of sales channels, and can subsequently order delivery of marine life at their convenience, without the need to find a store specializing in marine life.

In one embodiment, an aquarium is provided, comprising: a water-tight aquarium tank, an aquarium lid that covers said aquarium tank, a hatching compartment formed in said aquarium lid, and a magnification element atop said hatching compartment, said magnification element magnifying contents of said hatching compartment.

In another embodiment, a method for distributing marine life eggs can be applied in connection with such an aquarium. Such a method may include, for example, maintaining marine life eggs in a temperature-controlled environment, providing instructions for ordering said marine life eggs along with an aquarium such as that described above, receiving proof of purchase of such an aquarium, and in response to receiving proof of purchase, delivering said marine life eggs to an owner of said aquarium within a time frame to provide a high likelihood of a successful hatch.

Other advantages and features of the invention are described below.

### BRIEF DESCRIPTION OF THE DRAWINGS

An easy hatch aquarium and method for distributing marine life, in accordance with the present invention, is further described with reference to the accompanying drawings in which:

FIG. 1 illustrates an exemplary easy hatch aquarium.

FIG. 2 illustrates an exploded view of various exemplary components of the easy hatch aquarium, along with elements of a kit that may be sold along with the easy hatch aquarium.

FIG. 3 illustrates a top view of an exemplary aquarium lid.

FIG. 4 illustrates a bottom view of an exemplary aquarium lid and hatching compartment.

FIG. 5 illustrates an exemplary method for distributing marine life.

### DETAILED DESCRIPTION

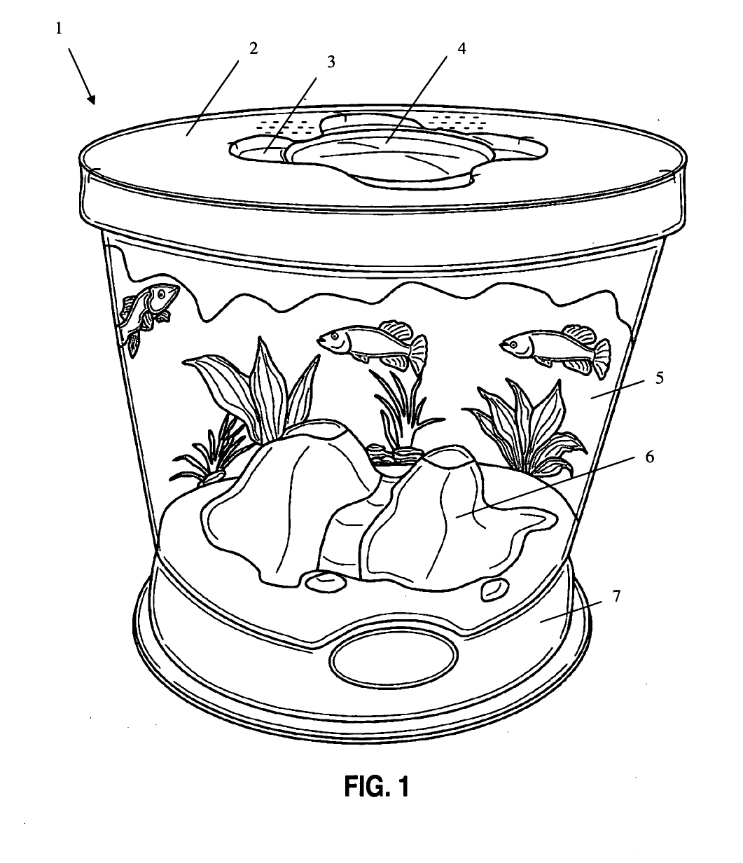

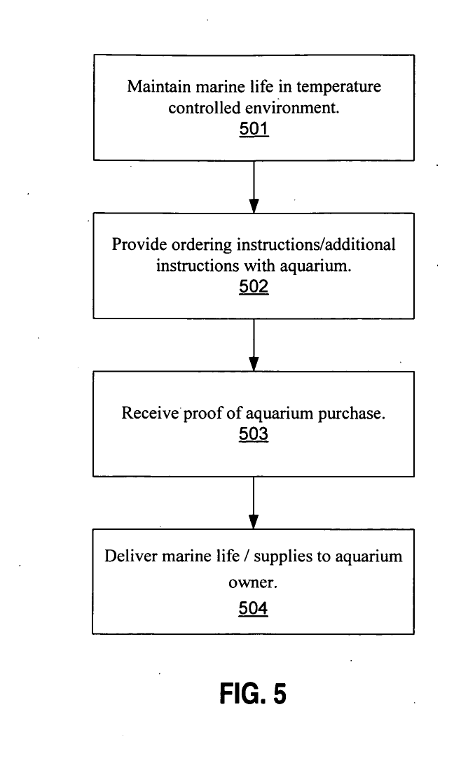

An exemplary easy hatch aquarium is described below in connection with FIGS. 1-4, followed by description of an exemplary method for distributing marine life in connection with FIG. 5. Certain specific details are set forth in the following description and figures to provide a thorough understanding of various embodiments of the invention. Certain well-known details often associated with manufacturing of articles such as an aquarium are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

FIG. 1 illustrates an exemplary easy hatch aquarium 1, including an aquarium tank 5, aquarium lid 2, hatching compartment 3 and magnification element 4. Also illustrated in FIG. 1 are base 7 and landscaping 6, such as rocks and plants, either real or artificial.

The aquarium tank 5 provides a water-tight main compartment in which liquid such as fresh water or salt water may be disposed, and in which marine life such as fish, shrimp, and aquatic plants may be kept. The tank 5 may be made of a transparent material such as clear plastic or glass.

The tank 5 should be stable to prevent it from tipping over and spilling out its contents. The tank may thus be disposed atop a base element 7 to optimize stability. The dimensions of the tank 5 are also chosen to achieve good stability. For example, in one embodiment, the tank 5 may be about seven inches wide on its long axis, about five inches wide on its short axis, and about seven inches tall including the base element 7.

Tank 5 dimensions can be further selected to optimize the tank 5 size for its likely location and for the space needs of the marine life that will live in the tank 5. For example, when the aquarium 1 is intended for educational home use by a child raising killifish, the tank 5 may be made suitably small as to easily fit on a surface in a child's bedroom or toy room, while also providing ample room for the killifish to swim about. The dimensions recited above are suited for this location and fish type. Other locations and other fish types may require different dimensions of tank 5.

Landscaping 6 may be included to provide visual interest to the aquarium 1, and to enhance the environmental quality of the tank 5 for marine life that may come to inhabit the tank 5. Landscaping 6 may include, for example, sculpted mounds as shown or artificial rocks and plants. A decorative mural may be applied to a tank 5 sidewall, depicting additional plants, fish, and marine life as illustrated in FIG. 1 to enhance the marine-looking habitat provided by the tank 5.

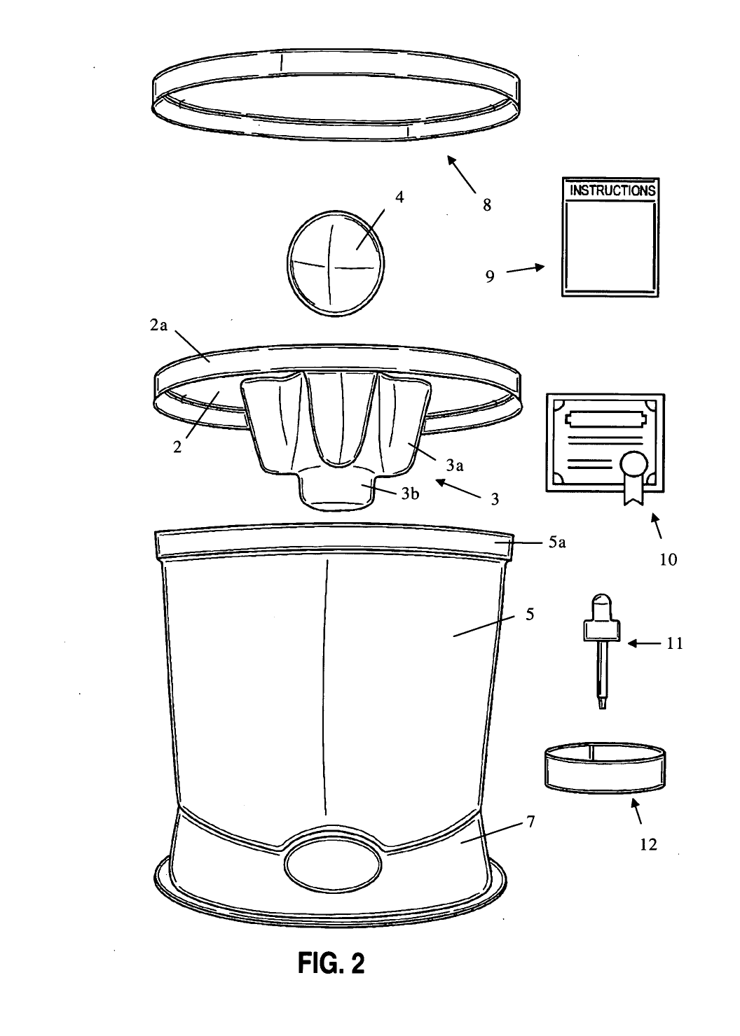

An aquarium lid 2 may be disposed atop the tank 5. In general, the lid 2 allows access to the contents of the tank 5 by being removably couplable to the tank 5. The lid 2 may be entirely removable from the tank 5, or may be attached to the tank 5 by means of hinges, tethers, slide guys, springs and the like. In the illustrated embodiment, the tank 5 is an open-top tank and the lid 2 is designed to fit snugly over the top of the tank 5. This aspect of the lid 2 can be further appreciated with reference to FIG. 2, which shows a lid rim 2a designed to fit snugly over a tank rim 5a. This prevents spillage that may occur from handling the aquarium 1. It will be appreciated that other tank and lid types can also be used, for example a flat lid without rim 2a would serve the function of covering the tank 5 and possibly preventing some spillage, while likely being less effective for spillage prevention.

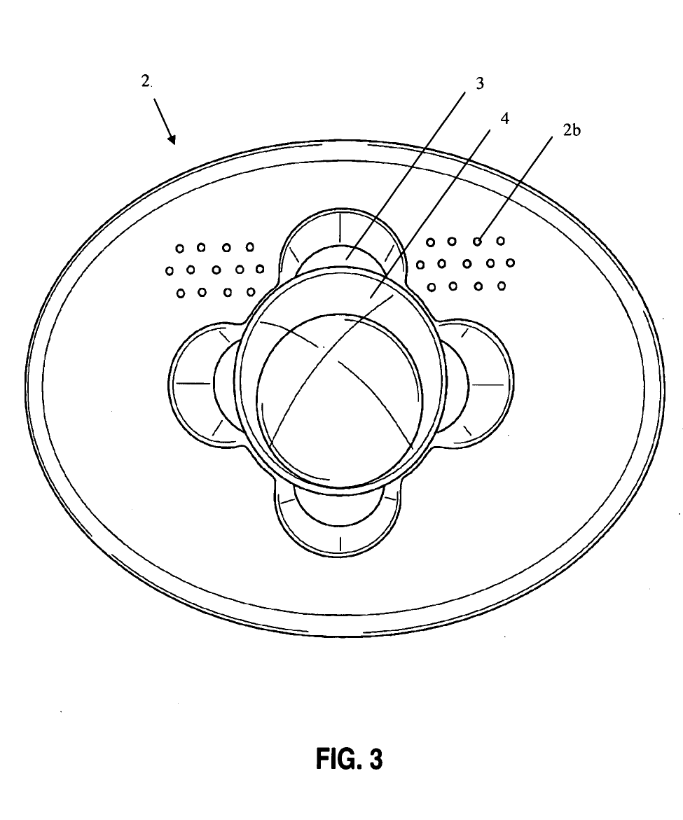

FIG. 3 illustrates perforations 2b that maybe advantageously disposed on lid 2 to allow for air and/or liquids to pass through the lid 2. Perforations 2b prevent a vacuum from forming in the tank 5 when removing the lid 2.

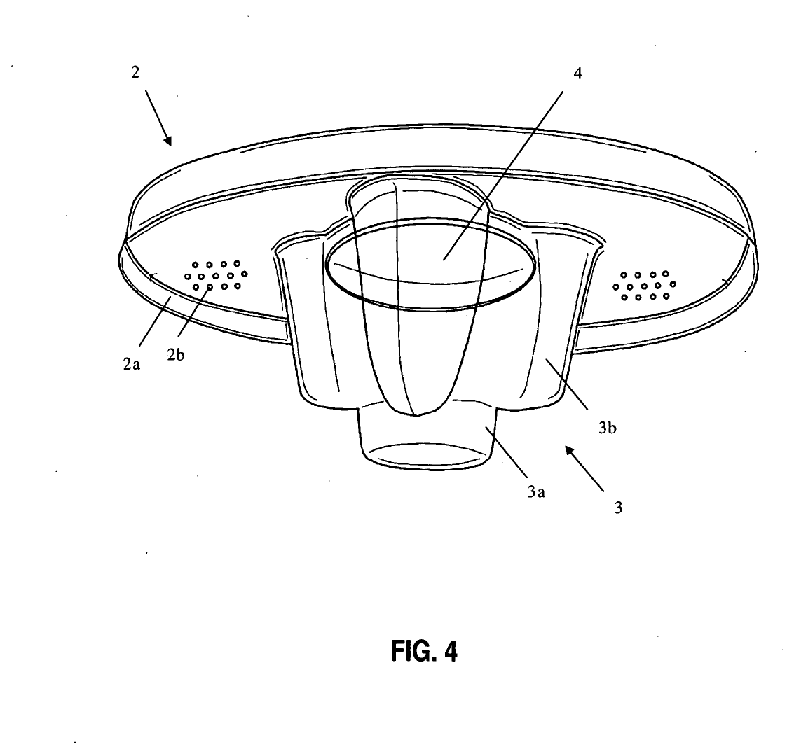

A hatching compartment 3 provides a water-tight compartment that is separate from the main compartment provided by the tank 5. The hatching compartment 3 thus provides a separate, controlled environment for hatching of marine life eggs. A hatching compartment 3 may be disposed in the lid 2 as illustrated in FIG. 4. This location for the hatching compartment 3 is advantageous because it allows for easily viewing the contents of the hatching compartment 3 by looking down at the lid 2. This location also allows the hatching compartment to be open at the top of the hatching compartment 3 for easy removal and replacement of the magnification element 4 without spilling the contents of the hatching compartment 3, and for easy lift and transfer of the contents of the hatching compartment 3 to the tank 5 without spilling the contents of the hatching compartment 3. While there are advantages to placing a hatching compartment 3 in lid 2 as shown, other configurations are also possible and the invention is not necessarily limited to the illustrated placement of hatching compartment 3. The hatching compartment 3 is small so that the new fish hatchlings can easily and quickly find the daily brine shrimp feed, as discussed in more detail below.

A hatching compartment 3 may be configured with a bottom well 3a and side wells 3b as illustrated in FIG. 4. The bottom well 3a provides a location in which marine life eggs and related matter such as coir may settle during the hatching process. When the bottom well is disposed directly underneath the magnification element 4, the location of the settled marine life eggs is optimized for viewing with the magnification element 4. The side wells 3b allow for easy placement and removal of the magnification element 4 atop the hatching compartment. Fingers can enter the hatching compartment 3 through the side wells 3b, and thereby grasp the magnification element 4 from both top and bottom to remove and replace it.

Referring now to FIG. 3, it can be seen that the topmost portion of the hatching compartment 3 can be designed to snugly hold in place a magnification element 4. This is accomplished in the embodiment of FIG. 3 by the form-fitting corner portions of the top of the hatching compartment 3, located between the various side wells 3b, along with small “shelves” formed underneath such corner portions, which hold the magnification element snugly over the center of the hatching compartment 3.

Magnification element 4 serves to magnify the contents of the hatching compartment 3. Magnification element 4 can comprise any of a wide array of available magnification apparatus. In the illustrated embodiment, magnification element 4 is a round lens that is removably disposed over the hatching compartment 3. The lens has a focal length that is tailored to the depth of the hatching compartment 3, for optimal viewing of hatching activity in the hatching compartment 3. Magnification element 4 can be made of a transparent material such as glass or plastic. By allowing complete removal of the magnification element 4, placement of marine life eggs into the hatching compartment 3 is facilitated, as is subsequent removal of hatched marine life. However, partial removability or non-removability of the magnification element 4 may also be applied in some embodiments.

FIG. 2 illustrates various additional components that may be sold as a kit along with the aquarium 1. For example, the kit may include a second aquarium dust cover lid 8 with air hole perforations and without a hatching compartment for use when the hatching compartment is no longer necessary. The kit may include instructions 9 for ordering marine life, hatching marine life, and subsequent care and feeding of marine life, as described further below. The kit may also include information 10 such as a proof-of-purchase certificate order card for ordering marine life and/or additional aquarium accessories and supplies. The marine life that may be ordered using information 10 may be predetermined according to aquarium type or purchase price paid. For example, predetermined marine life that may be ordered in one embodiment includes fish eggs such as killifish eggs for hatching in the hatching compartment 3, sea salt, coir and brine shrimp eggs for growing brine shrimp to feed to the killifish. In another embodiment, the information 10 may allow a certain amount of customer selection of marine life and additional accessories upon ordering. The kit may also include a bowl 12 for hatching shrimp eggs, and a water dropper 11 for transferring hatched shrimp from the bowl 12 to the hatching compartment 3.

The instructions 9 included with the kit may include, for example, instructions for ordering delivery of marine life eggs, e.g. the killifish eggs and/or the brine shrimp eggs, referenced above. The instructions may further include instructions for causing said killifish eggs to hatch, instructions for causing said brine shrimp eggs to hatch, instructions for feeding hatched brine shrimp to hatched killifish, and instructions for releasing the fish from the hatching compartment 3 into the aquarium tank 5 when appropriate. Care of the fish in the aquarium will continue thereafter.

Many marine life eggs are best kept in a controlled environment, at an appropriate predetermined temperature for the eggs. To optimize hatching success, a method according to FIG. 5 may be applied for distributing eggs in a manner that maintains an optimal environment for as long as possible. An exemplary method includes, for example, maintaining said marine life eggs in a temperature controlled environment 501, such as a professionally maintained distribution facility.

Instructions are provided to the purchaser of the aquarium for ordering said marine life eggs from the temperature-controlled environment 502. For example, instructions are included with an aquarium as described above, and released into the stream of commerce along with the aquarium, to eventually fall into the hands of a purchaser and owner of the aquarium. As described above, the aquarium will comprise a hatching compartment for hatching said marine life eggs, and a main compartment as an environment for the hatched marine life. Further instructions may be provided along with an aquarium as discussed above, namely instructions for causing fish eggs (e.g. killifish eggs) to hatch in said hatching compartment, instructions for causing brine shrimp eggs to hatch, and instructions for periodically feeding hatched brine shrimp to hatched fish. This could be daily or some other period.

Next, the method includes receiving proof of purchase of said aquarium 503, e.g. by a purchaser of an aquarium who is following instructions provided along with the aquarium. The proof of purchase may be received for example over the internet, by maintaining a website that allows purchasers to enter a product identification code and/or serial number of the purchased aquarium.

In response to receiving the proof of purchase, marine life eggs and related items such as brine shrimp eggs, sea salt, and coir, are delivered to an owner of said aquarium 504. To minimize the time that the marine life eggs are subjected to a non ideal environment, the owner may be instructed to begin the hatching process immediately or shortly after the marine life eggs are delivered.

In light of the diverse easy hatch aquarium configurations that may be built according to the general framework provided herein, the articles and methods provided herein cannot be construed as limited in any way to a particular architecture. Instead, the disclosed invention should be construed in breadth and scope in accordance with the appended claims. The above apparatus and method provide a high success opportunity for hatching and maintaining actual marine fish in an aquarium environment, as opposed to just brine shrimp.

1. An aquarium, comprising:
a water-tight aquarium tank;
an aquarium lid that covers said aquarium tank;
a hatching compartment formed in said aquarium lid; and
a magnification element atop said hatching compartment, said magnification element magnifying contents of said hatching compartment.

2. The aquarium of claim 1, further comprising instructions for ordering delivery of marine life eggs.

3. The aquarium of claim 2, wherein said marine life eggs include at least brine shrimp eggs or killifish eggs.

4. The aquarium of claim 3, further comprising instructions for causing said killifish eggs to hatch, instructions for causing said brine shrimp eggs to hatch, and instructions for feeding hatched brine shrimp to hatched killifish.

5. The aquarium of claim 1, further comprising a water dropper.

6. The aquarium of claim 1, wherein said aquarium lid comprises at least one perforation.

7. The aquarium of claim 1, further including a second aquarium lid, said second aquarium lid comprising a dust cover with air hole perforations, without a hatching compartment.

8. An aquarium, comprising:
an aquarium;
a hatching compartment formed in said aquarium, said hatching compartment comprising a water-tight compartment for hatching marine life eggs, and wherein said hatching compartment is separate from a main compartment of said aquarium; and
a magnification element magnifying contents of said hatching compartment.

9. The aquarium of claim 8, wherein the hatching compartment is sufficiently small so the new fish hatchlings can easily and quickly locate feed placed in the compartment.

10. The aquarium of claim 8, wherein said magnification element is removable.

11. The aquarium of claim 8, wherein said hatching compartment is formed in a lid of said aquarium.

12. The aquarium of claim 8, further comprising instructions for ordering delivery of fish eggs and shrimp eggs, instructions for causing said fish eggs to hatch in said hatching compartment, instructions for causing said shrimp eggs to hatch, and instructions for feeding hatched shrimp to hatched fish.

13. A method for distributing marine life eggs, comprising:
maintaining said marine life eggs in a controlled environment;
providing instructions for ordering said marine life eggs with an aquarium, said aquarium comprising a hatching compartment for hatching said marine life eggs, and a main compartment as an environment for the hatched marine life;
receiving proof of purchase of said aquarium; and
in response to said step of receiving, delivering said marine life eggs for use in said aquarium.

14. The method of claim 13, said marine life eggs including killifish eggs.

15. The method of claim 14, further comprising delivering brine shrimp eggs, sea salt, and coir along with said killifish eggs.

16. The method of claim 15, further comprising providing instructions for causing said killifish eggs to hatch in said hatching compartment, instructions for causing said brine shrimp eggs to hatch, and instructions for feeding hatched brine shrimp to hatched killifish.
